(19) United States
(12) Patent Application Publication
(10) Pub. No.: US 2011/0034149 A1
(43) Pub. Date: Feb. 10, 2011

(54) METHOD FOR RELEASING A MOBILE COMMUNICATION CARD FOR THE USE OF A SERVICE OF A MOBILE COMMUNICATION NETWORK AND USER EQUIPMENT FOR INTERACTION WITH A MOBILE COMMUNICATION NETWORK

(75) Inventor: Walter MOHRS, Bonn (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: DEUTSCHE TELEKOM AG, Bonn (DE)

(21) Appl. No.: 12/835,008

(22) Filed: Jul. 13, 2010

Related U.S. Application Data
(60) Provisional application No. 61/225,291, filed on Jul. 14, 2009.

(30) Foreign Application Priority Data
Jul. 14, 2009 (EP) 09 009 185.1

(51) Int. Cl. H04W 12/06

(52) U.S. Cl. 455/411

(57) ABSTRACT

A method for releasing a mobile communication card for the use of a service of a mobile communication network, wherein the service is usable with a user equipment, the user equipment comprising a contactless interface, includes in a first step, at least temporarily activating the mobile communication card and in a second step, releasing the use of the service based on an identifier of the mobile communication card and based on at least one authentication parameter of an electronic passport. The at least one authentication parameter is transmitted via the contactless interface.

### CROSS-REFERENCE TO RELATED APPLICATIONS

Priority is claimed to European Patent Application No. EP 09 009 185.1, filed Jul. 14, 2009 and U.S. Provisional Application No. 61/225,291, filed Jul. 14, 2009. The entire disclosure of both applications is incorporated by reference herein.

### FIELD

The present invention relates to a method for releasing a mobile communication card for the use of a service of a mobile communication network that allows performing a remote-controlled online activation of the mobile communication card in the mobile communication network.

### BACKGROUND

A method for releasing a mobile communications card for the use of a mobile communications network is described in WO 2009/071 146 A1, wherein a first activation of the mobile communications card occurs, particularly by the mobile communication network operator, and an identifier of the mobile communications card, particularly an MSISDN associated with the mobile communications card, is stored, wherein and additional permanent release of the mobile communications card is necessary in order to use the services of the mobile communications network, which occurs in that, using the identifier of the mobile communications card, and initial authentication process is performed after a temporary release of the mobile communications card.

Furthermore WO 00/79 822 A1 describes a method and a device for accessing a telecommunications network and for billing telecommunications services, whereby new processes compared to those of classic mechanisms of network providers are presented, services are offered to their customers and fees are charged for providing the same. In this context, the use of an authentication method in the telecommunications network is disclosed which permits a subscriber to certify at any one freely eligible point in time that a payment of a service which has been solicited or which is to be solicited is provided or has been already provided.

### SUMMARY

In an embodiment, the present invention provides method for releasing a mobile communication card for the use of a service of a mobile communication network, wherein the service is usable with a user equipment, the user equipment comprising a contactless interface. The method includes in a first step, at least temporarily activating the mobile communication card and in a second step, releasing the use of the service based on an identifier of the mobile communication card and based on at least one authentication parameter of an electronic passport. The at least one authentication parameter is transmitted via the contactless interface.

### BRIEF DESCRIPTION OF THE DRAWINGS

FIG. 1 illustrates a schematic flow chart of a first step of a method according to an exemplary embodiment of the present invention.

FIG. 2 illustrates a schematic flow chart of a second step of a method according to a first exemplary embodiment of the present invention.

FIG. 3 illustrates a schematic flow chart of a second step of a method according to a second exemplary embodiment of the present invention.

### DETAILED DESCRIPTION

Characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

Embodiments of the invention provide a method for releasing a mobile communication card, wherein the user of the mobile communication card is securely and doubtless identifiable without the need for face-to-face registration of the user at a service desk of the mobile communication network provider.

Embodiments of the invention include a method for releasing a mobile communication card for the use of a service of a mobile communication network, wherein the service is usable with a user equipment, the user equipment comprising a contactless interface, wherein in a first step the mobile communication card is at least temporarily activated and wherein in a second step the use of the service is released based on an identifier of the mobile communication card and based on at least one authentication parameter of an electronic passport, wherein the at least one authentication parameter being transmitted via the contactless interface. The invention further relates to a method for releasing a mobile communication card for the use of a service of a mobile communication network, wherein in a first step the mobile communication card is at least temporarily activated and wherein in a second step the use of the service is released based on an identifier of the mobile communication card and at least one authentication parameter of an electronic passport.

According to embodiments of the present invention, it is advantageously possible that the mobile communication card is released for the use of a service of a mobile communication network by a remote-controlled online activation procedure, wherein the mobile communication network provider is capable of securely and doubtless identifying the identity of the user of the mobile communication card. Consequently, the charges for using the service of the mobile communication network can particularly be allocated to the identified user and a misuse due to a wrong login name or a faked identity can be avoided. Preferably, the mobile communication card is provisionally activated by the provider of the mobile communication network in the first step. Subsequently, the mobile communication card is e.g. distributed gratis to a user by the aid of advertising brochures, prospects, inserts of a magazine, booths or the like. A user intending to use the mobile communication card of the mobile communication network provider has to insert the mobile communication card into his user equipment, his cellular phone for instance. Furthermore, the user has to provide his user equipment, especially his cellular phone, with the at least one authentication parameter of his electronic passport, like the user's name. Afterwards, the identifier of the mobile communication card and the at least one authentication is submitted to the mobile communication network provider via the mobile communication network, for example, so that a conclusion of a contract between the mobile communication network provider and the user relating the use of the service of the mobile communication network is achieved and the mobile communication card can be released for the service of the mobile communication network in a remote-controlled manner. According to the present invention, the user equipment comprises a contactless interface, e.g. an NFC interface and/or an RFID interface and/or a ISO/IED 14443 (A, B and/or C) interface, such that the at least one authentication parameter (of the electronic passport or of another electronic document) being transmitted via the contactless interface of the user equipment, e.g. the cellular phone. It is important according to the present invention that the contactless interface is no “wireless interface” in the sense of, e.g., a short range radio interface such as Bluetooth, WLAN or the like, or even a wide area radio interface such as a GSM or Universal Mobile Telecommunications System (UMTS) radio interface. Thereby, it is advantageously possible according to the present invention that a high level of security can be achieved when transmitting the at least one authentication parameter from the electronic passport (or other electronic document). As a consequence of such an enhanced level of data security and data integrity realized by enforcing the use of the contactless interface, it is possible to remotely authenticate the user in view of—for example—a contract related to the use of mobile communication services. Beneficially, the method according to the present invention allows the conclusion of the contract between the mobile communication network provider and the user because the user is securely and doubtless identifiable by the provider of the mobile communication network. The chronological order of accomplishing the first and the second step is arbitrary in the sense of the present invention. The first step can be performed before performing the second step and vice versa.

Preferably, a permanent or a temporarily use of the service is released in the second step. Consequently, a final activation of the mobile communication card is provided in such a manner, that the services of the mobile communication network, like calling, taking calls, sending messages and the like, can be customary used with the mobile communication card as if the mobile communication card has been released for a certain user via face-to-face registration at a service desk of the mobile communication network provider. Alternatively, the service is released only for a certain time period. In another embodiment of the present invention, the mobile communication card is already finally activated for use of standard services in the mobile communication network, wherein the mobile communication card is released by the present method to specific network-services going beyond the standard services, wherein these specific network-services generates additional fees. Suchlike specific network-services comprise calling chargeable telephone numbers or setting up international telephone calls, for instance. Preferably, the second step is evidence for final commissioning a SIM-card (Subscriber Identity Card) or an UICC-card (Universal Integrated Circuit Card).

Preferably, in the second step the identifier and/or the at least one authentication parameter is submitted cryptographically secured to the mobile communication network to increase the data integrity and the protection of the data privacy.

Method according to claim 1, wherein in the second step age, gender, place of residence and/or nationality of the user of the mobile communication card is transmitted to the mobile communication network and/or inquired by the mobile communication network. Beneficially, the mobile communication network provider inquires the age of the user for those services which features general age restrictions. As the age of the user is specified in the data of the electronic passport, a secure remote-controlled verification of the user's age can be performed by the mobile communication network provider before releasing the mobile communication card to services with age restrictions. Furthermore, the present invention provides e.g. specific services which are provided only for user's living in a certain place of residence and/or being a member of a certain nationality or religion.

Preferably, in the second step the authenticity of the identifier and/or of the at least one authentication parameter is verified. In particular, the mobile communication network provider verifies the at least one authentication parameter. For example, the mobile communication network provider compares the age restriction of a certain service with the submitted age of user derived from the electronic passport. In another embodiment, the mobile communication network provider inquires the cellular phone of the user, if the age of the user exceeds a certain age restriction. Subsequently, the cellular phone verifies the age of the user derived from the electronic passport and submits only a “TRUE” or “FALSE”-answer to the mobile communication network. Beneficially, this procedure provides a high protection of data privacy.

Another object of the present invention is a user equipment (UE) for interaction with a mobile communication network comprising a card reader for reading out a mobile communication card and an identification device for reading out an electronic passport, wherein the user equipment further comprises a transmitter unit for submitting an identifier of the mobile communication card and at least one authentication parameter of the electronic passport to the mobile communication network. Beneficially, the user equipment is capable of providing authentication parameters of an electronic passport. As a result, a securely and doubtless identification of the user of the user equipment by the mobile communication network provider is feasible, so that during the first usage of the mobile communication card in the user equipment a valid conclusion of a contract between the mobile communication network provider and the user of the user equipment is practicable. Preferably, the user equipment comprises an encryption unit for encrypting the at least one authentication parameter to increase the data integrity and the protection of the data privacy.

In a preferred embodiment of the present invention the user equipment comprises a personal computer and/or a portable electronic device, particularly a cellular phone, a personal digital assistant (PDA), a digital audio player and/or a laptop.

Embodiments of the invention provide a user equipment, which is released for a service of a mobile communication network by performing a method according to the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

According to embodiments of the present invention a more efficient utilization of the infrastructure of mobile radio networks is possible, especially for the situation where a compatibility with an older standard of mobile radio communication has to be assured, e.g., with respect to older mobile devices.

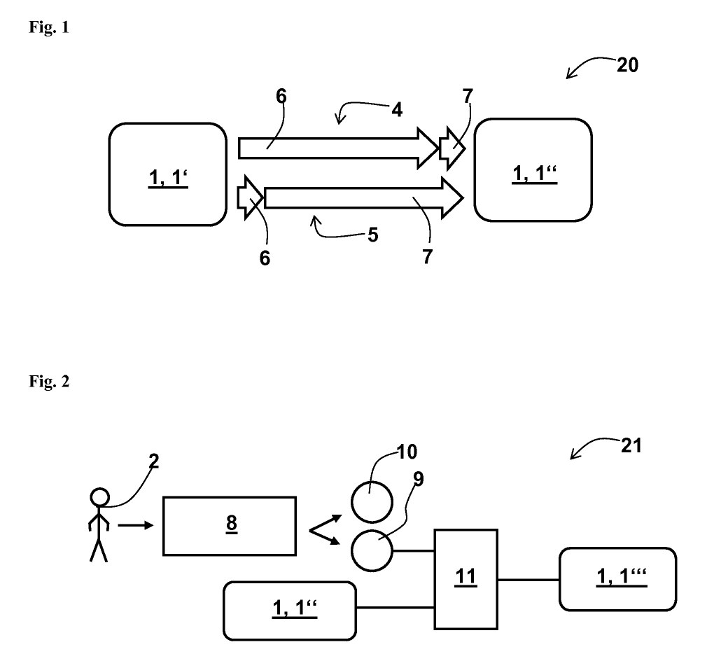

FIG. 1 illustrates an exemplary schematic flow chart of a first step 20 of a method according to an exemplary embodiment of the present invention, wherein in the first step 20 a brand-new mobile communication card 1 is activated and personalized to a certain user 2 for potential use in a mobile communication network. The step of activation and personalization comprises a first sub-step 6 of the first step 20 which is performed locally and respectively offline by the provider 15 of the mobile communication network and a second sub-step 7 of the first step 20 which is performed remote-controlled and respectively online by the provider 15. FIG. 1 shows two different ways 4, 5 of performing the first step 20. In the first way 4 the impersonalized mobile communication card 1′ is converted into a personalized mobile communication card 1″ by mainly using the first sub-step 6 of the first step 20, whereby in the second way 5 mainly the second sub-step 7 of the first step 20 is used. Preferably, the mobile communication card 1 is activated only temporarily.

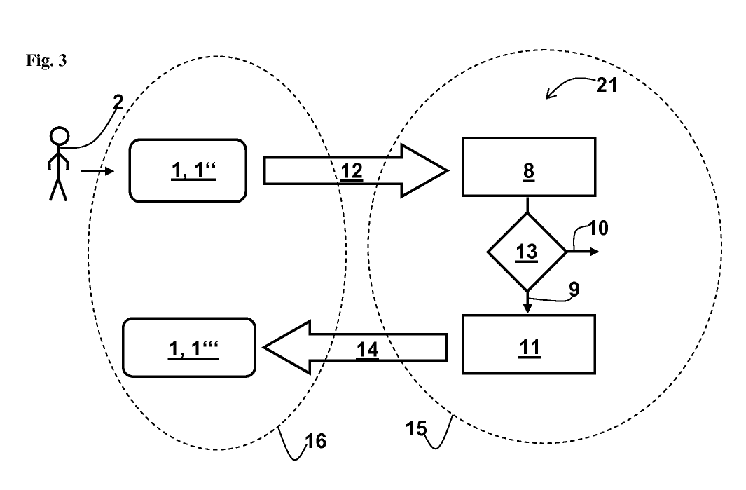

FIG. 2 illustrates a schematic flow chart of a second step 21 of a method according to a first exemplary embodiment of the present invention, wherein the second step 21 preferably follows the first step 20 as illustrated in FIG. 1. The second step 21 comprises a first sub-step 8 of the second step 21 verifying if the user's 2 identity is conform with a corresponding authentication parameter of his electronic passport. For example, the user 2 enters his name, wherein in the first sub-step 8 of the second step 21 the entered name is compared to the name derived from the electronic passport. The first sub-step 8 of the second step 21 is performed by a user equipment 16, like a cellular phone, which is provided with the mobile communication card 1. The result of the first sub-step 8 of the second step 21 is either “TRUE” 9 or “FALSE” 10. If the result of the first sub-step 8 of the second step 21 is “TRUE” 9 and the mobile communication card 1, 1″ is already activated in the first step 20 the mobile communication card 1, 1″ is released for a service of the mobile communication network in a second sub-step 11 of the second step 21. Preferably, the released mobile communication card 1, 1′ is released for performing at least customary services of the mobile communication network, like communication, message and telephone services.

FIG. 3 illustrates a schematic flow chart of a second step 21 of a method according to a second exemplary embodiment of the present invention, wherein the second exemplary embodiment is quite similar to the first exemplary embodiment, wherein the verification of the user's identification is performed by the mobile communication network provider 15. The activated and respectively personalized mobile communication card 1, 1″ submits a release request 12 to the mobile communication network provider 15, wherein the provider 15 verifies the release request by comparing the user identification with the authentication parameters of the electronic passport in the first sub-step 8 of the second step 21. The result of the verification procedure is requested in a further step 13. If the result is “TRUE” the mobile communication network provider 15 releases the mobile communication card 1, 1″ in the second sub-step 11 of the second step 21 for the use of services of the mobile communication network in a remote-controlled online procedure 14.

In an exemplary embodiment, the mobile communication card 1, 1″ is provisionally activated by the provider 15 of the mobile communication network in the first step 20 as illustrated in FIG. 1. Afterwards, the mobile communication card 1, 1″ is attached to an advertising insert of a magazine. The reader of the magazine inserts the activated mobile communication card 1, 1″ to his cellular phone 16 and enters personal information, like his name and his home address. Furthermore, the cellular phone 16 is provided with the corresponding authentication parameters of the electronic passport of the user 2, so that the provider 15 or alternatively the cellular phone 16 is capable of validating the personal information entered by the user 2 and securely identifies the user 2. An identifier of the mobile communication card 1, 1″ and the personal information or the authentication parameters are submitted from the cellular phone 16 to the provider 15. This procedure allows the conclusion of a contract between the mobile communication network provider 15 and the user 2. Subsequently, the mobile communication network provider 14 releases the mobile communication car 1, 1″' for services of the mobile communication network, wherein the charges for using these services are allocated to the new account of the identified user 2.

While the invention has been particularly shown and described with reference to preferred embodiments thereof, it will be understood by those skilled in the art that various changes in form and details may be made therein without departing from the spirit and scope of the invention.

1-13. (canceled)

14. A method for releasing a mobile communication card for the use of a service of a mobile communication network, wherein the service is usable with a user equipment, the user equipment comprising a contactless interface, the method comprising:
in a first step, at least temporarily activating the mobile communication card; and
in a second step, releasing the use of the service based on an identifier of the mobile communication card and based on at least one authentication parameter of an electronic passport, wherein the at least one authentication parameter is transmitted via the contactless interface.

15. The method of claim 14, wherein the second step further comprises submitting the at least one authentication parameter to a provider of the mobile communication network in such a manner, that the service is remotely released for the mobile communication card.

16. The method of claim 15, wherein the second step further comprises submitting cryptographically secured at least one of the identifier and the at least one authentication parameter to the provider of the mobile communication network.

17. The method of claim 14, wherein in the second step, the released use is a permanent or a temporary use.

18. The method of claim 14, wherein in the second step further comprises authenticating a user's personal identity.

19. The method of claim 14, wherein the second step further comprises transmitting at least one of the age, gender, place of residence and nationality of the user of the mobile communication card to the provider of the mobile communication network.

20. The method of claim 14, wherein the second step further comprises inquiring, by the provider of the mobile communication network, at least one of the age, gender, place of residence and nationality of the user of the mobile communication card.

21. The method of claim 14, wherein the second step further comprises verifying at least one of the authenticity of the identifier and the at least one authentication parameter.

22. The method of claim 14, wherein at least one of the first step and the second step is performed by at least one of the provider of the mobile communication network and the user equipment, and wherein the user equipment is provided with the mobile communication card.

23. The method of claim 14, wherein the second step provides evidence for final commissioning a SIM-card (Subscriber Identity Card) or an UICC-card (Universal Integrated Circuit Card).

24. User equipment for interaction with a mobile communication network, the user equipment comprising:
a card reader configured to read out a mobile communication card,
an identification device configured to read out data of an electronic passport, the identification device being provided as a contactless interface, and
a transmitter unit configured to submit an identifier of the mobile communication card and at least one authentication parameter of the electronic passport to the provider of the mobile communication network, wherein the at least one authentication parameter is transmitted via the contactless interface.

25. The user equipment of claim 24, further comprising an encryption unit for encrypting the at least one authentication parameter.

26. The user equipment of claim 24, wherein at least one of the card reader, the identification device and the transmitter unit are disposed in at least one of a personal computer, a cellular phone, a personal digital assistant (PDA), a digital audio player and a laptop.
